(19) United States
(12) Patent Application Publication
(10) Pub. No.: US 2024/0203169 A1
(43) Pub. Date: Jun. 20, 2024

(54) SYSTEMS AND METHODS FOR CONTROLLING DATA TRANSMISSION FROM VEHICLES

(71) Applicant: Bendix Commercial Vehicle Systems LLC, Avon, OH (US)

(72) Inventors: Andreas KUEHNLE, Strängnäs (SE); Steve SU, Irvine, CA (US)

(73) Assignee: Bendix Commercial Vehicle Systems LLC, Avon, OH (US)

(21) Appl. No.: 18/082,336

(22) Filed: Dec. 15, 2022

(51) Int. Cl. G07C 5/00; G07C 5/08

(52) U.S. Cl. CPC G07C 5/008; G07C 5/0816; G07C 5/0841

(57) ABSTRACT

The present disclosure is directed to system and methods for controlling data transmission from vehicles to external servers. In one form, a processor of a system is configured to identify a potential abnormality within data of a data transmission from a vehicle to an external server; adjust the data transmission after identifying the potential abnormality; transmit a first indicator from the vehicle to the server that is configured to indicate at least one of the potential abnormality or an adjustment of the data transmission; receive a second indicator from the server that is configured to indicate how to adjust the data transmission; and adjust or maintain, based on the second indicator, the data transmission.

### BACKGROUND

With the advancement of computer systems within vehicles, large amounts of data are regularly wirelessly transmitted between a vehicle and servers of external systems. For example, in a commercial setting, a vehicle may regularly wirelessly transmit information to servers of a commercial fleet system regarding a location of the vehicle and/or a current state of systems within the vehicle. Similarly, consumer vehicles may regularly wirelessly transmit information with servers of online services such as those from vehicle manufacturers regarding a location of the vehicle and/or a current state of systems within the vehicle.

Transmitting large amounts of data over wireless networks, such as cellular networks, between vehicles and external servers can be expensive. Accordingly, it is desirable to ensure that data transmitted between vehicles and external servers is valid data.

### SUMMARY OF THE DISCLOSURE

The present disclosure addresses the above problem and provides systems and methods for controlling data transmission from vehicles. As described below, the present disclosure provides implementations that detect patterns for excessive data transmission from vehicles and perform operations to automatically modify data transmission from vehicles based on the detected patterns.

In one form, the present disclosure provides a system comprising a memory and a processor configured to execute instructions stored in the memory. The processor is further configured to identify a potential abnormality within data that is part of a data transmission from a vehicle to a server external to the vehicle, the data comprising at least one of vehicle information, driver information, or environmental information and to adjust an amount of data in the data transmission from the vehicle to the server after identifying the potential abnormality.

The processor is further configured to transmit a first indicator from the vehicle to the server, the first indicator configured to indicate to the server at least one of the potential abnormality or an adjustment of the data transmission; receive a second indicator from the server, the second indicator configured to indicate to the processor how to at least one of adjust the amount of data in the data transmission from the vehicle to the server or maintain the amount of data in the data transmission from the vehicle to the server; and adjust or maintain, based on the second indicator, at least one of the amount of data in the data transmission from the vehicle to server or content of the data transmission from the vehicle to the server.

In another form, the present disclosure provides a method in which a processor identifies a potential abnormality within data that is part of a data transmission from a vehicle to a server external to the vehicle, the data comprising at least one of vehicle information or driver information and adjusts, after identifying the potential abnormality, an amount of data in the data transmission from the vehicle to the server.

The processor is further configured to transmit a first indicator from the vehicle to the server, the first indicator configured to indicate to the server at least one of the potential abnormality or an adjustment of the data transmission; receive a second indicator from the server, the second indicator configured to indicate to the processor at least one of how to adjust the amount of data in the data transmission from the vehicle to the server or to maintain the amount of data in the data transmission from the vehicle to the server; and adjust or maintain, based on the second indicator, at least one of the amount of data in the data transmission from the vehicle to server or content of the data transmission from the vehicle to the server.

In a further form, the present disclosure provides a system comprising a memory and a processor configured to execute instructions stored in the memory. The processor is further configured to receive a data transmission from a vehicle, the data transmission comprising data that comprises at least one of vehicle information, driver information, or environmental information, and to receive a first indicator from the vehicle, the first indicator configured to indicate at least one of a potential abnormality within the data or that the amount of data in the data transmission has been adjusted based on an identification of the potential abnormality within the data.

The processor is further configured to analyze, based on the identification of the potential abnormality within the data, at least a portion of the data of the data transmission that was received prior to the first indicator and determine, based on the analysis of the at least a portion of the data transmission, whether the potential abnormality is valid data. The processor is further configured to send a second indicator to the vehicle, the second indicator configured to instruct the vehicle, based on the determination of whether the potential abnormality is valid data, how to adjust or maintain at least one of the amount of data in the data transmission from the vehicle or content of the data transmission from the vehicle to the server.

In yet another form, the present disclosure provides a method in which a processor receives a data transmission from a vehicle, the data transmission comprising data that comprises at least one of vehicle information or driver information and receives a first indicator from the vehicle, the first indicator configured to indicate at least one of a potential abnormality within the data or that the amount of data in the data transmission has been adjusted based on an identification of the potential abnormality within the data.

The processor is further configured to analyze, based on the identification of the potential abnormality within the data, at least a portion of the data of the data transmission that was received prior to the first indicator and determine, based on the analysis of the at least a portion of the data transmission, whether the potential abnormality is valid data.

The processor is further configured to send a second indicator to the vehicle, the second indictor configured to instruct the vehicle, based on the determination of whether the potential abnormality is valid data, how to adjust or maintain at least one of the amount of data in the data transmission from the vehicle or content of the data transmission from the vehicle to the server.

### BRIEF DESCRIPTION OF THE DRAWINGS

FIG. 1 is a block diagram of an example environment in which systems and methods for controlling data transmission from vehicles may operate.

FIG. 2 is a flow chart of one form of a method for controlling data transmission from a vehicle at the vehicle.

FIG. 3 is a flow chart of one form of a method for detecting a potential abnormality based on duplicated event data.

FIG. 4 is a flow chart of one form of a method for a server external to a vehicle to analyze data transmissions from the vehicle.

### DETAILED DESCRIPTION OF THE DRAWINGS

The present disclosure is directed to systems and methods for controlling data transmission from vehicles. As described below, the present disclosure provides implementations that provide the ability to detect patterns of excessive data transmission from vehicles and automatically perform operations such as reducing and/or terminating data transmission from vehicles based on the detected patterns of excessive data transmission.

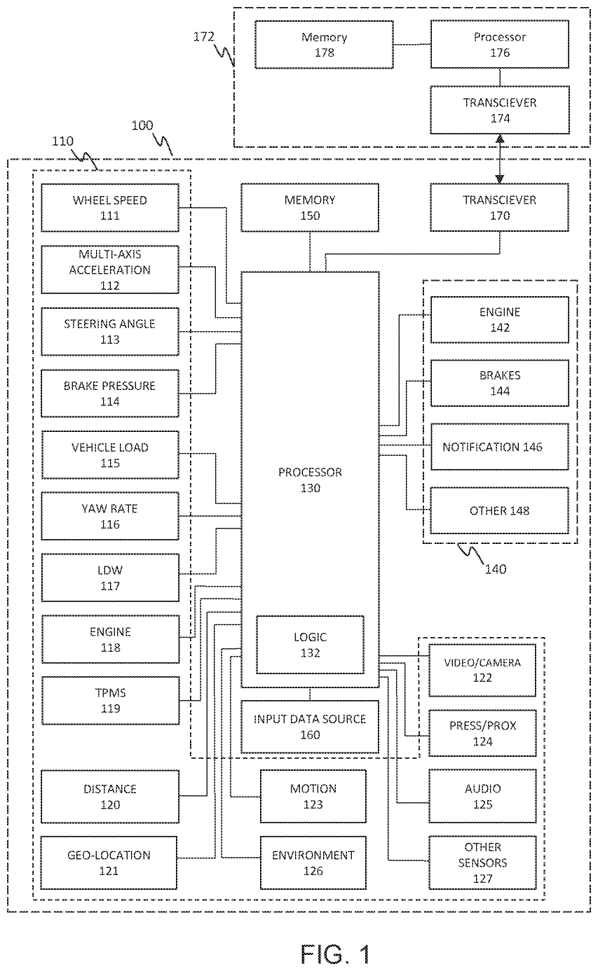

FIG. 1 is a block diagram of an environment in which a system for controlling data transmission from vehicles may operate. In some implementations, a vehicle system 100 generates data may be adapted to detect a variety of operational parameters and conditions of a vehicle and a driver's interaction therewith (i.e., event-based data, performance-based data, etc.) and, based thereon, to make various determinations such as whether a driving and/or vehicle and/or environmental event has occurred (e.g., if one or more operational parameter/condition thresholds has been exceeded). The data related to detected events or vehicle conditions may then be stored at the vehicle and/or transmitted to an external location/device (e.g., backend server, dispatch center computer, mobile device, etc.), and one or more vehicle systems can be controlled based thereon.

The system 100 may include one or more devices or systems 110 for providing vehicle and/or driver related data, including data indicative of one or more operating parameters or one or more conditions of a commercial vehicle, its surroundings and/or its cabin occupants. The system 100 may, alternatively or additionally, include a signal interface for receiving signals from the one or more devices or systems 114, which may be configured separate from system 100. For example, the devices 110 may be one or more sensors, such as but not limited to, one or more wheel speed sensors 111, one or more acceleration sensors such as multi-axis acceleration sensors 112, a steering angle sensor 113, a brake pressure sensor 114, one or more vehicle load sensors 115, a yaw rate sensor 116, a lane departure warning (LDW) sensor or system 117, one or more engine speed or condition sensors 118, and a tire pressure (TPMS) monitoring system 119. The system 100 may also utilize additional devices or sensors, including for example a forward distance sensor and/or a rear distance sensor 120 (e.g., radar, lidar, etc.) and/or a geo-location sensor 121. Additional sensors for capturing driver related data may include one or more video sensors 122 and/or motion sensors 123, pressure or proximity sensors 124 located in one or more seats and/or driver controls (e.g., steering wheel, pedals, etc.), audio sensors 125, or other sensors configured to capture driver related data. The system 100 may also utilize environmental sensors 126 for detecting circumstances related to the environment of the driving excursion, including for example, weather, road conditions, time of day, traffic conditions, etc. Other sensors 127, actuators and/or devices or combinations thereof may be used or otherwise provided as well, and one or more devices or sensors may be combined into a single unit as may be necessary and/or desired. For example, biometric sensors may be included for detecting biometric data of the vehicle occupants.

The system 100 may also include a logic applying arrangement such as a controller or processor 130 and control logic 132, in communication with the one or more devices or systems. The processor 130 may include one or more inputs for receiving data from the devices or systems. The processor 130 may be adapted to process the data and compare the raw or processed data to one or more stored threshold values or desired averages or value ranges, or to process the data and compare the raw or processed data to one or more circumstance-dependent desired value or evolution, so as to detect one or more driver and/or vehicle related events, for example.

The processor 130 may also include one or more outputs for delivering a control signal to one or more vehicle control systems 140 based on, for example, the detection of the event(s) and/or in response to vehicle and/or driver related data. The control signal may instruct the systems 140 to provide one or more types of driver assistance warnings (e.g., warnings relating to braking, obstacle avoidance, driver performance, passenger performance, etc.) and/or to intervene in the operation of the vehicle to initiate corrective action. For example, the processor 130 may generate and send the control signal to an engine electronic control unit 142 or an actuating device to reduce the engine throttle and slow the vehicle down. Further, the processor 130 may send the control signal to one or more vehicle brake systems 144 to selectively engage the brakes (e.g., a differential braking operation). A variety of corrective actions may be possible and multiple corrective actions may be initiated at the same time. It will be understood that such corrective actions need not be contemporaneous with detected events and/or event data, and may, additionally or alternatively, be responsive to one or more historical records of detected events and/or event data.

The vehicle control components may further include brake light(s) and other notification devices 146, which may be configured to provide warnings and/or notifications externally to the vehicle surroundings and/or internally to the vehicle occupants. Example warnings and/or notifications include: headway time/safe following distance warnings, lane departure warnings, warnings relating to braking and or obstacle avoidance events, warnings related to driver performance, warnings related to passenger performance, and any other type of warning or notification in furtherance of the embodiments described herein. Other vehicle control systems 148 may also be controlled in response to detected events and/or event data.

The system 100 may also include a memory portion 150 for storing and accessing system information, such as for example the system control logic 132. The memory portion 150, however, may be separate from the processor 130. The sensors 110, controls 140 and/or processor 130 may be part of a preexisting system or use components of a preexisting system.

The system 100 may also include a source of vehicle-related input data 160, which may be indicative of a configuration/condition of the commercial vehicle and/or its environmental circumstances (e.g., road conditions, geographic area conditions, etc.). The processor 130 may sense or estimate the configuration/condition and/or environmental circumstances of the vehicle based on the input data, and may select a control tuning mode or sensitivity based on the vehicle configuration/condition and/or environmental circumstances. The processor 130 may compare the operational data received from the sensors 110 to the information provided by the tuning. Such tuning may be useful, for example, where a distracting passenger is present while driving a heavily loaded vehicle. Such input data may be further useful in evaluating driving performance.

In addition, the system 100 may be operatively coupled with one or more driver facing imaging devices, shown for simplicity and ease of illustration as a single driver facing camera 122 that is trained on the driver and/or trained on the interior of the cab of the commercial vehicle. However, it should be appreciated that one or more physical video cameras may be disposed on the vehicle such as, for example, a video camera on each corner of the vehicle, one or more cameras mounted remotely and in operative communication with the system 100 such as a forward-facing camera to record images of the roadway ahead of the vehicle. Such cameras may, for instance, indicate undesirable proximity to objects, the roadway verge, etc.

In some implementations, driver related data can be collected directly using the driver facing camera 122, such driver related data including head position, eye gaze, hand position, postural attitude and location, or the like, within the vehicle. In addition, driver identity and/or presence can be determined based on facial recognition technology, body/posture template matching, and/or any other technology or methodology for making such determinations by analyzing video data.

In operation, the driver facing camera 122 may capture video data of the image area. The video data may be captured on a continuous basis, or in response to a detected event. Such data may comprise a sequence of video frames with separate but associated sensor data that has been collected from one or more on-vehicle sensors or devices, as detailed herein.

The system 100 also includes a transmitter/receiver (transceiver) module 170 such as, for example, a radio frequency (RF) transmitter including one or more antennas for wireless communication of data and control signals, including control requests, event-based data, performance-based data, vehicle configuration/condition data, or the like, between the vehicle and one or more external locations/devices 172, such as, for example, back-end servers, dispatch center computers, and mobile devices, having a corresponding receiver and antenna 174.

The transmitter/receiver (transceiver) module 170 may include various functional parts or sub-portions operatively coupled with a platoon control unit including for example a communication receiver portion, a global position sensor (GPS) receiver portion, and a communication transmitter. For communication of specific information and/or data, the communication receiver and transmitter portions may include one or more functional and/or operational communication interface portions as well.

The processor 130 may be operative to select and combine signals from the sensor systems into event-based data and/or performance-based data representative of higher-level vehicle and/or driver related data. For example, data from the multi-axis acceleration sensors 112 may be combined with the data from the steering angle sensor 113 to determine excessive curve speed event data. Other hybrid data relatable to the vehicle and/or driver and obtainable from combining one or more selected raw data items from the sensors includes, for example and without limitation, excessive braking event data, excessive curve speed event data, lane departure warning event data, excessive lane departure event data, lane change without turn signal event data, lane change without mirror usage data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, following distance event data, fuel consumption event data, ACC usage event data, and late speed adaptation (such as that given by signage or exiting). Still other hybrid data relatable to the vehicle and/or driver and obtainable from combining one or more selected raw data items from the sensors includes, for example and without limitation, driver out of position event data, passenger out of position event data, driver distracted event data, driver drowsy event data, driver hand(s) not on wheel event data, passenger detected event data, wrong driver event data, seatbelt not fastened event data, driver cellphone use event data, distracting passenger event data, mirror non-use event data, unsatisfactory equipment use event, driver smoking event data, passenger smoking event data, insufficient event response event data, insufficient forward attention event data. The aforementioned events are illustrative of the wide range of events that can be monitored for and detected by the driver event detection and reporting system 100, and should not be understood as limiting in any way.

The system 100 may further include a bus or other communication mechanism for communicating information, coupled with the processor 130 for processing information. The system may also include a main memory 150, such as random-access memory (RAM) or other dynamic storage device for storing instructions and/or loaded portions of a trained neural network to be executed by the processor 130, as well as a read only memory (ROM) or other static storage device for storing other static information and instructions for the processor 130. Other storage devices may also suitably be provided for storing information and instructions as necessary or desired.

In at least some implementations, the system 100 of FIG. 1 is configured to execute one or more software systems or modules that perform or otherwise cause the performance of one or more features and aspects described herein. Computer executable instructions may therefore be read into the main memory 150 from another computer-readable medium, such as another storage device, or via the transceiver 170. Execution of the instructions contained in main memory 150 may cause the processor 130 to perform one or more of the process steps described herein. In some implementations, hard-wired circuitry may be used in place of or in combination with software instructions to implement the invention. Thus, implementations of the example embodiments are not limited to any specific combination of hardware circuitry and software.

It will be appreciated that the external locations/device 172, such as external servers, may also include a processor 176 and memory 178 similarly configured for processing information and executing one or more software systems or modules that perform or otherwise cause the performance of one or more features and aspects described herein.

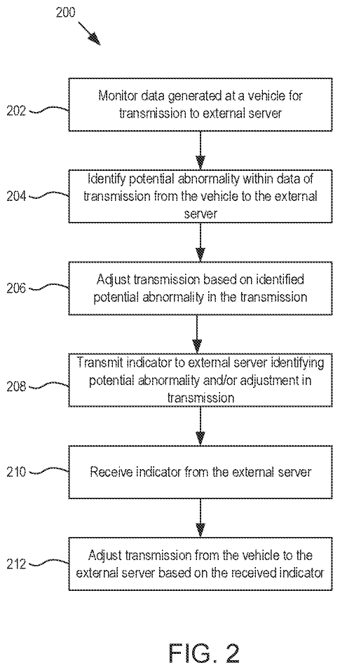

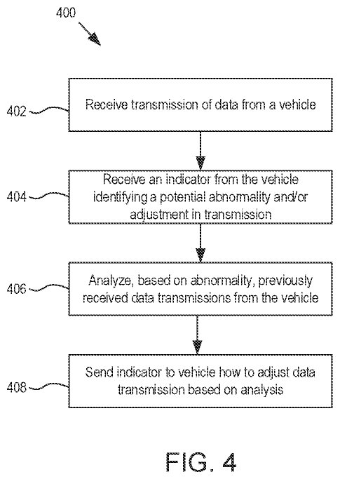

Methods for controlling data transmission from a vehicle, such as those described below, may be performed within the environment described above in conjunction with FIG. 1. It will be appreciated that the described methods of FIG. 2 may be performed within systems integrated in whole or in part in a vehicle or a handheld device of a driver such as a mobile phone or table while the described methods of FIG. 4 may be performed within systems integrated in whole or in part in servers that are part of a fleet control system or servers of online services such as those from vehicle manufacturers, for example.

FIG. 2 is a flow chart 200 of one form of a method for controlling data transmission from a vehicle at the vehicle.

At step 202, a processor of a vehicle monitors data generated at the vehicle at at least one of a controller, a sensor, or another system of a vehicle and transmitted to a server external to the vehicle. In some implementations, the data that is generated at the vehicle and is within the data transmission from the vehicle to the server external to the vehicle may comprise at least one of vehicle information, driver information, or environmental information, such as the information described above in conjunction with FIG. 1.

At step 204, the processor identifies a potential abnormality within data that is part of the data transmission from a vehicle to a server external to the vehicle. For example, the processor may determine that portions of sequential data within the data transmission repeat more than a sequentially repeating threshold; that portions of data repeat during a period of time more than a repeating threshold; or a portion of data that represent invalid vehicle performance measures.

In one illustrative example, an improperly installed vehicle system may produce an excessive number of excessive curve speed events. Curve speed events typically form less than three percent of data generated by a driver while operating a vehicle and normally occur at widely separated intervals. However, the improperly installed vehicle system may result in chains of excessive curve speed events and the excessive curve speed events may account for over 50% of data transmitted from the vehicle to an external server. When the processor observes that chains of curve speed events that are closely spaced in time are regularly reoccurring, the processor may identify this as a potential abnormality from how curve speed events typically occur.

In some implementation, the processor may consider vehicle condition when determining whether there is a potential abnormality in the data transmission. For example, a vehicle traveling predominantly at only low speeds is expected to have few events in comparison to a vehicle traveling at higher speeds, so a large number of detected events in a vehicle traveling at lower speeds may suggest a potential abnormality in the data.

In some implementations, the processor may further consider event to event content variation in determining whether there is a potential abnormality in the data transmission. For example, the processor may create a hash value for event data, and then compare this hash value for event data that is transmitted next. If the hashes match and the event is a type of occurrence that does not typically repeat, it suggests a potential abnormality in the data.

In further implementations, the processor may consider a threshold of a maximum percentages of events detected per set number of events, such as per 100 events. For example, a processor may typically detect a maximum percentage of 40% of lane departure warning events per 100 events. Based on this, the processor may in one example set a threshold of a maximum percentage of 60% of lane departure warning events per 100 events. Accordingly, if for a previous 100 events the processor detects 62% of events are lane departure warnings, the processor may determine there is a potential abnormality in the lane departure warning events and throttle lane departure warning events, as explained in more detail below. That is, the processor may implement event type specific throttling while permitting other non-anomalous event types to pass through without hindrance.

In yet further implementations, the processor considers whether a software design in a vehicle is causing a potential abnormality of excessive data being transmitted between the vehicle and an external server. For example, a vehicle that is continually driving at a speed that is greater than a speed limit may generate repeated ‘speeding!’ events.

To address these repeated events, the processor may implement a speed constancy check (e.g., determine whether cruise control is on) or implements a parameterized comparator and latch function. For example, when a vehicle is traveling 70 mph in an area where 60 mph is the limit, a limit value sets a comparator threshold to 60 mph, after which a repeated comparison of a current operating speed is made with the comparator value. If the speed drops below 60 mph, the latch stores this state, and the processor inhibits further speeding events from being sent. Once the speed limit changes, the latch is reset.

In another implementation, the processor may consider a spacing between events in a data transmission and determine if the spacing is consistent with the type of events when in determining whether there is a potential abnormality in the data transmission. For example, closely spaced lane departure warnings are common, but closely spaced excessive braking events are not common. Accordingly, the processor may determine that there is a potential abnormality and throttle closely spaced excessive braking events when a time gap between the excessive braking events is less than 60 seconds, for example. In some implementations, the processor may allow two excessive braking events less than 60 seconds apart to be transmitted, and then throttle transmission of a third excessive braking event within the 60 second limit (and a fourth after the third, etc). In some implementations, throttling an event or transmission of an event may include action such as preventing an event or transmission, reducing a number of events of transmission of events, or limiting a number of events or transmission of events.

In this illustrative example, the repeated events are not incorrect, but they add no new information, being continuations of the same event. It will be appreciated that the notion of no new added information may be applied to other events as well, such as continued inattention (measured by a driver facing camera). Once a state of attention has been reestablished, and inattention is then detected again, a new inattention event may be detected and sent.

As part of step 204, a further way in which the processor may identify a potential abnormality within data that is part of the data transmission from a vehicle to a server external to the vehicle is by considering whether a duplicated event percentage indicates excessive data transmission.

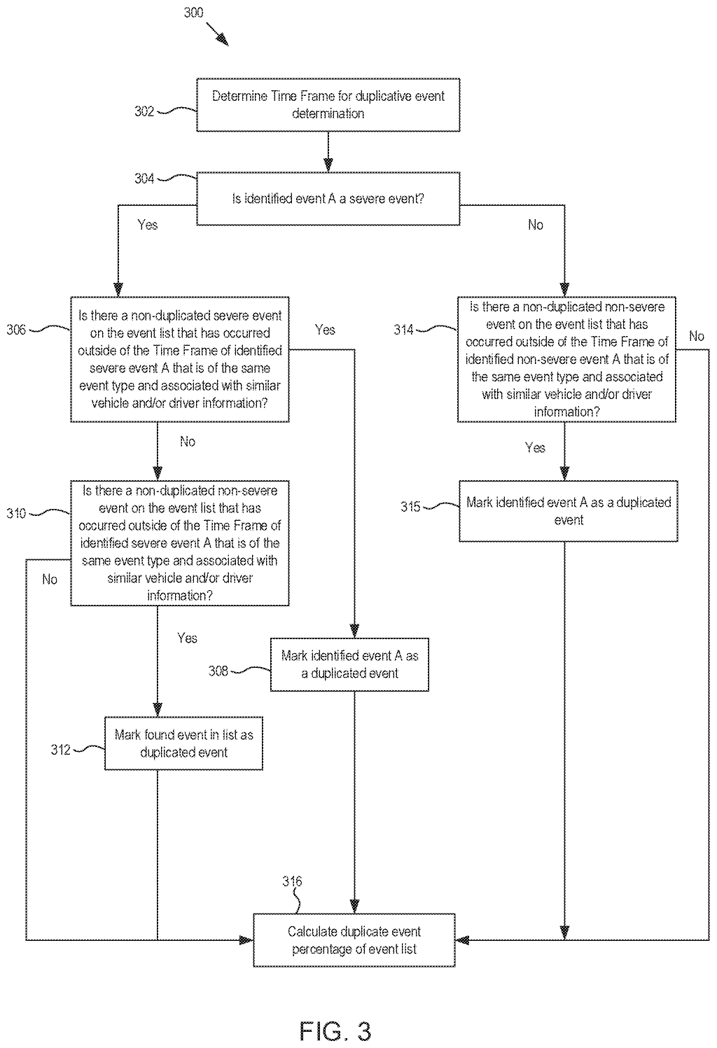

FIG. 3 is a flow chart of one form of a method for detecting a potential abnormality based on duplicated event data.

As discussed below, when determining whether vehicles are transmitting excessive data, the ability of a processor to identify a percentage of excessive data is important as a higher the percentage, the more likely the vehicle is sending too much data. One excessive data type, among others, is duplicated event data. In some implementations where a vehicle includes an event data buffer, the processor may purposefully err and preferentially falsely identify excessive data transmission too often, and then rely on the server to correct the false identification of excessive data and instruct the vehicle to send data stored in the event data buffer of the vehicle.

In some implementations, a processor of the vehicle may determine that event A is a duplicated event of event B when both event A and event B are of the same event type and are associated with the same vehicle and driver information, such as a vehicle ID and a driver ID, and event A and event B occur with a defined period of time, such as 60 seconds.

It will be appreciated that the defined period of time that the processor examines whether two events occur within can change depending on factors such as a type of vehicle fleet and/or an event type. One company may prefer to have 60 seconds as the criteria to identify duplicated events, while another company may prefer to use 120 seconds. With respect to event type, for most event types, 60 seconds as the criteria to identify duplicative events is considered to be a desirable timeframe to check the duplication. However, it will be appreciated that for events such as an “Over Speed” event, 120 seconds is considered to be a better criteria to identify duplicative events for some companies.

An additional factor that may be considered when detecting a duplication of events is an event severity. In some implementations, not all events with the same event type are equal in terms of the importance for users. In these implementations, a severe event is normally more important than the non-severe event, even though the two events are the same event type. Accordingly, in these circumstances, it is important not to regard one severe Over Speed event (for example, at 20 miles over a speed limit) to be a duplicated event simply because there is another non-severe Over Speed Event (for example, at 5 miles over a speed limit) that occurred within a defined period of time, such as just 30 seconds ago.

Referring to FIG. 3, at step 302, the processor of the vehicle begins a method to determine event duplications by determining a timeframe for duplicative event determinations. In some implementations, the processor determines a timeframe for duplicative event determinations by examinating a table stored at the vehicle that identifies a timeframe for specific event types, a timeframe for event types as defined for a specific fleet of vehicles, and/or a timeframe for event types for all fleets of vehicles. One example table is shown below.

TABLE 1

| Fleet# | EventType | TimeFrame (seconds) |
|---|---|---|
| 1 | Overspeed | 120 |
| 1 | | 65 |
| * | | 60 |

In the illustrative table, for Fleet #1's Overspeed event, if event A is within 120 seconds of event B, the processor detects a potential abnormality. For other Fleet #1 event types, if event A is within 65 seconds of event B, the processor detects a potential abnormality. For all other fleets and all event types, if event A is within 60 seconds of event B, the processor detects a potential abnormality.

At step 304, the processor determines whether an identified event A is a severe event. In some implementations, the processor determines whether the identified event is a severe event based on defined rules. For example, if an acceleration is greater that 0.4 g for at least 1.0 second, the processor may determine an acceleration event to be severe. Similarly, in another example, when a lane departure is detected and the vehicle is determined to be 20 cm or more beyond a lane marking, the processor may determine that a lane departure warning is severe.

When the processor determines at step 304 that the identified event A is a severe event, the processor proceeds at step 306. At step 306, the processor compares identified severe event A to a list of events that occurred prior to identified severe event A to determine whether a severe event on the list of events that has not previously been determined to be a duplicated event has occurred outside the defined timeframe of the identified severe event A that is of the same event type and that is associated with similar vehicle and/or driver information, such as a vehicle identifier or driver identifier.

When the processor determines at step 306 that there is a recorded non-duplicated severe event on the event list that has occurred outside the defined timeframe of the identified severe event A that is of the same event type and is associated with similar vehicle and/or driver information, the processor determines that the identified severe event A is a duplicated event and records it as such at step 308. The method then proceeds to step 316 described below.

Alternatively, when the processor determines at step 306 that there is not a recorded non-duplicated severe event on the event list that has occurred outside the defined timeframe of the identified severe event A that is of the same event type and is associated with similar vehicle and/or driver information, the method proceeds to step 310.

The processor determines at step 310 whether there is a recorded non-duplicated non-severe event on the event list that has occurred outside the defined timeframe of the identified severe event A that is of the same event type and is associated with similar vehicle and/or driver information, such as a vehicle identifier and/or driver identifier.

When the processor determines at step 310 that there is a recorded non-duplicated non-severe event on the event list that has occurred outside the defined timeframe of the identified severe event A that is of the same event type and is associated with similar vehicle and/or driver information, the processor determines at step 312 that the recorded non-duplicated non-severe is a duplicative event and records it as such. The method then proceeds to step 316.

Alternatively, when the processor determines at step 310 that there is not a recorded non-duplicated non-severe event on the event list that has occurred outside the defined timeframe of the identified severe event A that is of the same event type and that is associated with similar vehicle and/or driver information, the method proceeds to step 316.

Referring again to step 304, when the processor determines that the identified event A is not a severe event, the processor proceeds at step 314. At step 314, the processor determines whether a recorded non-duplicated event on the event list has occurred outside the defined timeframe of the identified event A that is of the same event type and is associated with similar vehicle and/or driver information, such as a vehicle identifier or driver identifier.

When the processor determines at step 314 that there is a recorded non-duplicated event on the event list that has occurred outside the defined timeframe of the identified event A that is of the same event type and is associated with similar vehicle and/or driver information, at step 315 the processor determines that identified event A is a duplicated event and records it as such. The method then proceeds to step 316.

Alternatively, when the processor determines at step 314 that there is not a recorded non-duplicated event on the event list has occurred outside the defined timeframe of the identified event A that is of the same event type and is associated with similar vehicle and/or driver information, the method proceeds to step 316.

At step 316, the processor determines a calculated duplicated event percentage for the list of events based on the number of events on the list of events that has been determined to a duplicated event. In some implementations, the duplicated event percentage is calculated based on a number of duplicated events in the list of events divided by a total number of events in the list of events.

It will be appreciated that as new events occur, the processor may add events to the list of events, update information identifying whether the events on the list of events are duplicated events, and repeat the above-described method to regularly calculate a calculated event percentage of the list of events.

Referring again to FIG. 2, after identifying the potential abnormality within data of the data transmission, at step 206, the processor adjusts an amount of data in the data transmission from the vehicle to the server. In some implementations, the processor may reduce the amount of data in the data transmission from the vehicle to server or cease the data transmission from the vehicle to the server. In some implementations, adjusting an amount of data in a data transmission may also include changing a character of the data in the data transmission. For example, the processor may adjust a density of the data, a content of the data, and/or a resolution associated with data. For instance, the processor may transmit lower resolution imagery, transmit lower quality imagery, transmit less frequently sampled signals, and/or transmit lower bit resolution for signals (e.g., 8 bit vs. 16 bit).

Further, in some implementations, the processor may treat transmission of different data types differently depending on the identified potential abnormality. For example, the processor may cease data transmission or reduce the amount of data in the data transmission of a first data type that is associated with the identified potential abnormality and maintain, increase, decrease, or cease data transmission of a second data type from the vehicle to server that may not be associated with the identified potential abnormality.

As noted above, modifying a transmission of a data type may include changing a sampling interval of a data type, changing a resolution of a data type, and/or changing fields of a data type that are transmitted between a vehicle and an external server. Accordingly, it will be appreciated that transmission of data between the vehicle and server may not be purely on or off. The processor may implement a reduced data transmission mode, where for example, the processor only transmits to the server plus or minus two seconds of data around a trigger time of an event, or where the processor transmits video data less densely, e.g. at a frame rate of one frame per second instead of five or ten frames per second. Such reduced, but not stopped, data transmission may be signaled to the server also, which then performs a reasonableness analysis, as discussed below.

One of skill in the art will appreciate that by generally reducing the amount of data transmitted and/or adjusting transmission of types of data associated with the identified potential abnormality, the processor improves a quality of the data transmitted from the vehicle to an external server after identification of the potential abnormality.

At step 208, the processor transmits a first indicator from the vehicle to the server that is configured to indicate to the server an identified potential abnormality and/or an adjustment of the data transmission. In some implementations, the processor receives an acknowledge from the server of the first indicator.

In one illustrative example, the processor may identify a potential abnormality of a gross excess of (fictitious or improperly triggered due to faulty sensor installation) excessive curve speed events. Such events form typically less than three percent of a driver's data, occurring at widely separated intervals but aberrant systems can produce chains of excessive curve speed events, and account for great than 50% of the data transmitted. When event chains start occurring—excessive curve speed events closely spaced in time—and then recur, it suggests improper installation of a sensor and/or equipment utilized to detect excessive speed warning events.

This recurrent chaining is detected, and an identifier such as a ‘do not transmit’/‘only partially transmit’ signal associated with excessive curve speed events is sent to the external server. Because the external server has already received excessive curve speed events, the already received excessive curve speed event chains may be examined for plausibility, as explained in more detail below in conjunction with FIG. 4.

The external server may consider additional information when reviewing the already-received excessive curve speed events such as video, or location—on a straight road these are exceedingly rare—via handedness (improper installation can produce an excess of signals indicating going too fast clock- or counterclockwise).

For example, if the already-received excessive curve speed events indicate that 90% of lateral accelerations are going to the left, the measurements are suspect as on average, vehicles typically make a similar number of left-hand turns vs. right-hand turns over a period of time. Accordingly, these values would likely indicate a excessive curve speed sensor that was not properly installed or calibrated.

Similarly, if the server were reviewing events such as hard braking events that may be associated with the excessive curve speed events, the server would examine whether the hard braking events have a magnitude that would indicate improper installation or calibration of a sensor. For example, if a hard braking event is associated with a high deceleration of 1.2 g that would not normally occur, this value indicates improper installation or calibration of a sensor. Accordingly, in some implementations, both a handedness (left or right) of events, as well as a largest magnitude of the events, should be within a reasonable range or percentage to be acceptable and not cause throttling.

At step 210, the processor receives an indicator from the server and may send an acknowledgement of the indicator to the server, and step 212, the processor adjusts the data transmission from the vehicle to the external server based on the indicator received from the external server at step 210.

The indicator from the server indicates to the processor how to modify the amount of data in the data transmission from the vehicle to the server. For example, the server may indicate that the processor should adjust or maintain at least one of an amount of data in a data transmission from the vehicle to the server or content of the data transmission from the vehicle to the server.

In one example, this may include actions such as increasing an amount of data in the data transmission from the vehicle to the server when the indicator indicates that the potential abnormality is valid data. In another example, this may include actions such as at least one of adjusting or maintaining at least one of the content of the data transmission or the amount of data in the data transmission from the vehicle to the server when the second indicator indicates that the potential abnormality is not valid data.

In a further example, this may include actions such as cease data transmission or reduce the amount of data in the data transmission of a first data type from the vehicle to the server while also maintaining data transmission of a second data type from the vehicle to server.

Continuing with the example above, if the external server finds the excessive curve speed events to not be legitimate, the server may send an identifier to the vehicle to signal to the vehicle that it should only send information indicating that ‘an excessive speed event occurred’, without also sending information such as video, thereby saving bandwidth and cost. In some implementations, in these conditions a vehicle would not store excessive curve speed event video and/or flushes stored excessive curve speed event video in response, freeing (limited) event buffer memory for actual, non-fictitious, events. In some implementations, the external server may indicate that while these actions are to be taken with respect to data associated with excessive curve speed events, the transmission of other data types that were not associated with the identified potential abnormality should not be adjusted.

As discussed above in conjunction with step 208, when the processor transmits a first indicator from the vehicle to the external server that is configured to indicate to the server an identified potential abnormality in a data transmission and/or an adjustment of the data transmission, the external server may then analyze data from previous data transmission to determine whether the identified potential abnormality in the data transmission is valid.

FIG. 4 is a flow chart 400 of one form of a method a server external to a vehicle to analyze data transmissions from the vehicle. As noted above, in some implementations the external server may be part of a vehicle fleet control system utilized in commercial settings, for example, or may be part of servers of online services such as those from vehicle manufacturers, in another example. However, in other implementations, the external servers may be part of any service provide where data is transmitted form a vehicle to a server external to the vehicle.

At step 402 a processor of the server receives a data transmission from a vehicle, as discussed above. In some implementations, the data transmission includes data that comprises at least one of vehicle information, driver information, or environmental information.

At step 404, the processor of the server receives an indicator from the vehicle, as discussed above, that indicates to the server an identified potential abnormality and/or that an amount of data and/or content in the data transmission has been adjusted based on an identification of a potential abnormality within the data. In some implementations, the processor may send an acknowledgment of receipt of the indicator to the vehicle.

At step 406, the processor analyzes, based on the identification of the potential abnormality within the data, at least a portion of the data of the data transmission that was received prior to the first indicator and determines, based on the analysis of the at least a portion of the data transmission, whether the potential abnormality is valid data.

For example, the processor may analyze video or physical measure content of the at least one of vehicle information or driver information of the at least a portion of the data and determine, based on the analysis of the video or physical measure content, whether the potential abnormality is valid data, as explained in more detail below.

In another example, the processor may analyze pre-and-post-event data of the at least one of vehicle information or driver information of the at least a portion of the data and determine, based on the analysis of the pre-and-post-event data, whether the potential abnormality is valid data, as explained in more detail below.

In a further example, the processor may analyze vehicle information from a second vehicle in conjunction with analyzing the at least a portion of the data of the data transmission that was received from the vehicle prior to the first indicator and determine, based on the analysis of the vehicle information form the second vehicle, whether the potential abnormality is valid data. For instance, if an excessive number of warnings occurs at a particular location such as an extra narrow roadway or in an area with multiple tight S-curves, or during a particular time of day such as when the sun is positioned near the horizon in a view of a driver, the excess warnings may be common to multiple drivers (who do not see well in the lighting conditions or who do not expect the difficulties presented by the unexpected S-curves) and thereby vehicles, and therefore not a false warnings condition.

At step 408, the processor of the server sends an indicator to the vehicle that instructs the vehicle, based on the determination at step 406, how to adjust or maintain at least one of the amount of data in the data transmission from the vehicle or content of the data transmission from the vehicle to the server. In some implementations, the processor may receive an acknowledgment of the indicator from the vehicle.

In some implementations, the indicator instructs the vehicle to increase the amount of data in the data transmission from the vehicle when the potential abnormality is valid data, or alternatively, the indicator instructs the vehicle to, when the potential abnormality is invalid data, adjust or maintain at least one of the amount of data in the data transmission from the vehicle or content of the data transmission from the vehicle to the server.

Continuing with the illustrative examples described above where possible excess data is transmitted from the vehicle to the server, the server may receive an indicator identifying a potential abnormality of excessive data. In response, the server may then analyze previously-received data transmission to determine whether the identified potential abnormality of excessive data is valid.

When a vehicle transmits excessive data to the external server, the excessive data is often a result of two different types of data generation. In a first, a same event type is sent multiple times. In a second, an overflow of falsely triggered events occurs. It will be appreciated that defective sensor installation, defective sensors, and/or miscalibration of sensors can cause false triggering events. When false triggering events occurs, the same event type may be transmitted multiple times due to a continued condition, e.g. uninterrupted speeding, physical nearness to a threshold trigger value, or lane hugging causing frequent lane departure warnings. In a lane marking hugging state, for example, it arguably is irrelevant after a period of time to receive yet another lane departure, and it would instead be better to know that the driver has the lane hugging behavior. In some implementations, the processor of the external server is able to recognize each of these types of data generation and signal to the vehicle to adjust data transmissions to the server based on the identified type of excess data generation.

In reviewing the previously-received data transmission, the processor of the server may look for signatures of excessive data such as implausibly long repeating chains of a same type of event or an excess percentage of event types, such as where more than 40% of a data transmission is excessive braking.

When the processor identifies a signature such as the above, the processor of the server may analyze data of a transmission and determine a specific internal content of the data being sent. In one example, an internal pattern (a signature) is oscillations produced by a dangling camera that is no longer fixed to a windshield like it normally is, but instead may be hanging by electrical wires and swinging back and forth during movement of a vehicle. The processor may look for oscillations in the content of data being sent such as oscillations in acceleration signals, these being a pattern over time, or for oscillating content in video imagery, e.g. does the horizon periodically change angle.

In some implementations, to determine a specific internal content of the data being transmitted, the processor of the server may analyze video data and/or the processor of the server may analyze pre-and-post-event data. In analyzing video data, the processor may examine a content of the images being sent. For example, both a forward-facing camera and a driver-facing camera usually observe fixed vehicle features in their view. These fixed features may include a nose of a vehicle, cab furniture of the vehicle, and/or a driver in approximately the same location. Should a processor determine when analyzing the video data that these normally static objects are not in a fixed location from frame to frame of video data, the processor may determine that a video camera at the vehicle is loose and not generating helpful information. As a result, the processor may indicate to the vehicle, as discussed below, that video data from the compromised camera should be not be transmitted or should be severely reduced. Similarly, other events based on data from the compromised camera should likely not be relied upon.

In analyzing pre-and-post-event data, the processor may analyze internal details of events within previously-received data transmission from the vehicle. For example, the processor of the server may determine whether the same pre-and-post-event values are present at more than 10% of points in time in a pre-and-post-event series where the values would normally be different. When the processor identifies these repeated values, these repeated values suggest that data associated with the same event is repeatedly being transmitted from the vehicle to the server.

As a result, the processor may indicate to the vehicle, as discussed below, that data for the repeated pre-and-post-event should not be transmitted from the vehicle to the server. In some implementations, this pre-and-post-event repeated value check may retain knowledge of the previous same one or more type events and the associated pre-and-post-event data at specified time points (e.g. at −2 seconds, −1 second, and 0) therein. Further, the processor may determine whether the same values again occur during one or more subsequent events of the same type that occur in received data transmissions.

FIGS. 1-4 and their accompanying description described system and methods for controlling data transmission from vehicles to external servers. As described above, the present disclosure provides implementations that provide the ability to detect patterns of excessive data transmission from vehicles and automatically perform operations to modify data transmission from vehicles based on the detected patterns of excessive data transmission to improve the quality of data transmission between vehicles and external servers.

The foregoing disclosure has been set forth merely to illustrate the disclosure and is not intended to be limiting. Since modifications of the disclosed embodiments incorporating the spirit and substance of the disclosure may occur to persons skilled in the art, the disclosure should be construed to include everything within the scope of the appended claims and equivalents thereof.

1. A system comprising:
a memory
a processor configured to execute instructions stored in the memory and to:
identify a potential abnormality within data that is part of a data transmission from a vehicle to a server external to the vehicle, the data comprising at least one of vehicle information, driver information, or environmental information;
adjust an amount of data in the data transmission from the vehicle to the server after identifying the potential abnormality;
transmit a first indicator from the vehicle to the server, the first indicator configured to indicate to the server at least one of the potential abnormality or an adjustment of the data transmission;
receive a second indicator from the server, the second indicator configured to indicate to the processor at least one of how to adjust the amount of data in the data transmission from the vehicle to the server or to maintain the amount of data in the data transmission from the vehicle to the server; and
adjust or maintain, based on the second indicator, at least one of the amount of data in the data transmission from the vehicle to server or content of the data transmission from the vehicle to the server.

2. The system of claim 1, wherein the potential abnormality comprises at least one of:
portions of data that sequentially repeat more than a sequentially repeating threshold;
portions of data that repeat during a period of time more than a repeating threshold; or
a portion of data that represent invalid vehicle performance measures.

3. The system of claim 1, wherein to adjust the amount of data in the data transmission from the vehicle to the server, the processor is configured to:
reduce the amount of data in the data transmission from the vehicle to server.

4. The system of claim 1, wherein to adjust the amount of data in the data transmission from the vehicle to the server, the processor is configured to:
cease the data transmission from the vehicle to the server.

5. The system of claim 1, wherein to adjust the amount of data in the data transmission from the vehicle to the server, the processor is configured to:
cease data transmission or reduce the amount of data in the data transmission of a first data type from the vehicle to the server; and
maintain data transmission of a second data type from the vehicle to server.

6. The system of claim 1, wherein to adjust or maintain, based on the second indicator, at least one of the amount of data in the data transmission from the vehicle to server or content of the data transmission from the vehicle to the server, the processor is configured to:
increase an amount of data in the data transmission from the vehicle to the server when the second indicator indicates that the potential abnormality is valid data; and
at least one of adjust or maintain at least one of the content of the data transmission or the amount of data in the data transmission from the vehicle to the server when the second indicator indicates that the potential abnormality is not valid data.

7. A method comprising:
identifying, with a processor, a potential abnormality within data that is part of a data transmission from a vehicle to a server external to the vehicle, the data comprising at least one of vehicle information or driver information;
adjusting, with the processor, after identifying the potential abnormality, an amount of data in the data transmission from the vehicle to the server;
transmitting, with the processor, a first indicator from the vehicle to the server, the first indicator configured to indicate to the server at least one of the potential abnormality or an adjustment of the data transmission;
receiving, with the processor, a second indicator from the server, the second indicator configured to indicate to the processor at least one of how to adjust the amount of data in the data transmission from the vehicle to the server or to maintain the amount of data in the data transmission from the vehicle to the server; and
adjusting or maintaining, with the processor, based on the second indicator, at least one of the amount of data in the data transmission from the vehicle to server or content of the data transmission from the vehicle to the server.

8. The method of claim 7, wherein the potential abnormality comprises at least one of:
portions of data that sequentially repeat more than a sequentially repeating threshold;
portions of data that repeat during a period of time more than a repeating threshold; or
a portion of data that represent invalid vehicle performance measures.

9. The method of claim 7, wherein adjusting, after identifying the potential abnormality, an amount of data in the data transmission from the vehicle to the server comprises:
reducing the amount of data in the data transmission from the vehicle to server; or
ceasing the data transmission from the vehicle to the server.

10. The method of claim 7, wherein adjusting, after identifying the potential abnormality, an amount of data in the data transmission from the vehicle to the server comprises:
ceasing data transmission or reducing the amount of data in the data transmission of a first data type from the vehicle to the server; and
maintaining data transmission of a second data type from the vehicle to server.

11. A system comprising:
a memory; and
a processor configured to execute instructions stored in the memory and to:
receive a data transmission from a vehicle, the data transmission comprising data that comprises at least one of vehicle information, driver information, or environmental information;
receive a first indicator from the vehicle, the first indicator configured to indicate at least one of a potential abnormality within the data or that the amount of data in the data transmission has been adjusted based on an identification of the potential abnormality within the data;
analyze, based on the identification of the potential abnormality within the data, at least a portion of the data of the data transmission that was received prior to the first indicator and determine, based on the analysis of the at least a portion of the data transmission, whether the potential abnormality is valid data; and
send a second indicator to the vehicle, the second indicator configured to instruct the vehicle, based on the determination of whether the potential abnormality is valid data, how to adjust or maintain at least one of the amount of data in the data transmission from the vehicle or content of the data transmission from the vehicle to the server.

12. The system of claim 11, wherein to analyze, based on the identification of the potential abnormality within the data, at least a portion of the data of the data transmission that was received prior to the first indicator and determine, based on the analysis of the at least a portion of the data transmission, whether the potential abnormality is valid data, the processor is configured to:
analyze video or physical measure content of the at least one of vehicle information or driver information of the at least a portion of the data; and
determine, based on the analysis of the video or physical measure content, whether the potential abnormality is valid data.

13. The system of claim 11, wherein to analyze, based on the identification of the potential abnormality within the data, at least a portion of the data of the data transmission that was received prior to the first indicator and determine, based on the analysis of the at least a portion of the data transmission, whether the potential abnormality is valid data, the processor is configured to:
analyze pre-and-post-event data of the at least one of vehicle information or driver information of the at least a portion of the data; and
determine, based on the analysis of the pre-and-post-event data, whether the potential abnormality is valid data.

14. The system of claim 11, wherein to analyze, based on the identification of the potential abnormality within the data, at least a portion of the data of the data transmission that was received prior to the first indicator and determine, based on the analysis of the at least a portion of the data transmission, whether the potential abnormality is valid data, the processor is configured to:
analyze vehicle information from a second vehicle in conjunction with analyzing the at least a portion of the data of the data transmission that was received from the vehicle prior to the first indicator; and
determine, based on the analysis of the vehicle information form the second vehicle, whether the potential abnormality is valid data.

15. The system of claim 11, wherein the second indicator instructs the vehicle to increase the amount of data in the data transmission from the vehicle when the potential abnormality is valid data or the second indicator instructs the vehicle to, when the potential abnormality is invalid data, adjust or maintain at least one of the amount of data in the data transmission from the vehicle or content of the data transmission from the vehicle to the server.

16. A method comprising:
receiving, with a processor, a data transmission from a vehicle, the data transmission comprising data that comprises at least one of vehicle information or driver information;
receiving, with the processor, a first indicator from the vehicle, the first indicator configured to indicate at least one of a potential abnormality within the data or that the amount of data in the data transmission has been adjusted based on an identification of the potential abnormality within the data;
analyzing, with the processor, based on the identification of the potential abnormality within the data, at least a portion of the data of the data transmission that was received prior to the first indicator and determining, with the processor, based on the analysis of the at least a portion of the data transmission, whether the potential abnormality is valid data; and
sending, with the processor, a second indicator to the vehicle, the second indictor configured to instruct the vehicle, based on the determination of whether the potential abnormality is valid data, how to adjust or maintain at least one of the amount of data in the data transmission from the vehicle or content of the data transmission from the vehicle to the server.

17. The method of claim 16, wherein analyzing, based on the identification of the potential abnormality within the data, at least a portion of the data of the data transmission that was received prior to the first indicator and determining, based on the analysis of the at least a portion of the data transmission, whether the potential abnormality is valid data comprises:
analyzing, with the processor, video content of the at least one of vehicle information or driver information of the at least a portion of the data; and
determining, with the processor, based on the analysis of the video content, whether the potential abnormality is valid data.

18. The method of claim 16, wherein analyzing, based on the identification of the potential abnormality within the data, at least a portion of the data of the data transmission that was received prior to the first indicator and determining, based on the analysis of the at least a portion of the data transmission, whether the potential abnormality is valid data comprises:
analyzing, with the processor, pre-and-post-event data of the at least one of vehicle information or driver information of the at least a portion of the data; and
determining, with the processor, based on the analysis of the pre-and-post-event data, whether the potential abnormality is valid data.

19. The method of claim 16, wherein analyzing, based on the identification of the potential abnormality within the data, at least a portion of the data of the data transmission that was received prior to the first indicator and determining, based on the analysis of the at least a portion of the data transmission, whether the potential abnormality is valid data comprises:
analyzing, with the processor, vehicle information from a second vehicle in conjunction with analyzing the at least a portion of the data of the data transmission that was received from the vehicle prior to the first indicator; and
determining, based on the analysis of the vehicle information from the second vehicle, whether the potential abnormality is valid data.

20. The method of claim 16, wherein the second indicator instructs the vehicle to increase the amount of data in the data transmission from the vehicle when the potential abnormality is valid data or the second indicator instructs the vehicle, based on the determination of whether the potential abnormality is valid data, how to adjust or maintain at least one of the amount of data in the data transmission from the vehicle or content of the data transmission from the vehicle to the server.
